(19) United States
(12) Patent Application Publication
(10) Pub. No.: US 2026/0148894 A1
(43) Pub. Date: May 28, 2026

(54) Method for Manufacturing a Reactor and Reactor

(71) Applicant: Tamura Corporation, Tokyo (JP)

(72) Inventors: Kosuke Shibasaki, Sakado-shi (JP); Akihiro Shimizu, Sakado-shi (JP)

(21) Appl. No.: 19/396,002

(22) Filed: Nov. 20, 2025

(30) Foreign Application Priority Data
Nov. 25, 2024 (JP) 2024-204368

(51) Int. Cl. H01F 41/12; H01F 27/24; H01F 27/29; H01F 27/32; H01F 41/02

(52) U.S. Cl. CPC H01F 41/12; H01F 27/24; H01F 27/29; H01F 27/32; H01F 41/0206

(57) ABSTRACT

A method for manufacturing a reactor includes a bonding process of joining molded cores with a molded coil with an adhesive, and a welding process of connecting, by welding, the lead wire of a coil to a busbar fixed to the molded core. The coils are attached to respective leg portions. The bonding process includes an applying process of applying the adhesive to the joining surfaces of the respective leg portions of each of the core members, and the inner circumferential surfaces of the respective yoke portions of the core members, a depressing process of spreading the applied adhesive by depression, and a curing process of curing the adhesive.

### CROSS-REFERENCE TO RELATED APPLICATION

This application is based upon and claims the benefit of priority from Japan Patent Application No. 2024-204368, filed on Nov. 25, 2024, the entire contents of which are incorporated herein by reference.

### FIELD OF THE INVENTION

The present disclosure relates to a method for manufacturing a reactor provided with molded cores and a molded coil, and to a reactor.

### BACKGROUND

Reactors are applied to various applications, such as Office Automation equipment, solar power generation systems, automobiles, and uninterruptible power supplies. Reactors are electromagnetic components which convert electrical energy into magnetic energy, and which charge or discharge such energy.

A reactor includes a core and a coil. The core is a magnetic body, and has an annular shape. The coil is attached to the core. A lead wire is drawn out from the coil, and the lead wire is connected, by welding, to a busbar that electrically connects to an external device. Power is supplied to the coil via the busbar from the external device, and the coil generates magnetic fluxes. The core serves as a magnetic path through which the magnetic fluxes generated by the coil pass.

In order to insulate the core and the coil, the core and the coil may be molded respectively, and a reactor is produced by combining a molded core and a molded coil. For example, a projection is provided on the molded core, and a recess corresponding to the projection is provided on the molded coil, and a reactor is produced by fitting the projection of the molded core into the recess of the molded coil.

### SUMMARY OF THE INVENTION

The projection and the recess have a certain clearance even when fitted together, due to dimensional tolerance, and the like. Meanwhile, the reactor may be mounted in environments subject to vibration, such as in an automobile, for example. Therefore, when the reactor is mounted on an environment where vibration occurs, the molded core and the molded coil may move by the amount of the clearance, and excessive stress may be applied to, due to vibration, the welded portion where the busbar and the lead wire are connected, and thus a damage may be caused.

The present disclosure has been made in order to solve the above-described technical problem, and an objective is to provide a method for manufacturing a reactor and a reactor which firmly join molded cores and a molded coil, and which prevent damage to a welded portion between a busbar and a lead wire.

In order to accomplish the above objective, a method for manufacturing a reactor according to the present disclosure includes:
a molded core forming process of forming a pair of molded cores by molding at least respective parts of core members with a core molding resin;
a molded coil forming process of forming a molded coil by molding at least respective parts of coils with a coil molding resin;
a bonding process of joining the molded cores with the molded coil with an adhesive; and
a welding process of connecting, by welding, a lead wire of the one coil to a busbar fixed to the molded core,
in which:
   the core members each include a plurality of leg portions, and a yoke portion that connects the leg portions;
   the coils are attached to the respective leg portions;
   the bonding process includes:
   an applying process of applying the adhesive to joining surfaces of the respective leg portions of each of the core members, and an inner circumferential surface of the yoke portion of each of the core members or the molded coil that faces the inner circumferential surface of the yoke portion;
   a depressing process of spreading the applied adhesive by depression; and
   a curing process of curing the adhesive,
   in the depressing process, the adhesive applied to the joining surface is spread by depression onto at least one of an upper surface of the leg portion and a lower surface thereof, and at least one of inner side surfaces of the respective leg portions which are the surfaces of the respective leg portions of the one core member facing each other, and outer side surfaces of the respective leg portions which are surfaces each at an opposite side to the inner side surface, and to stick to the molded coil.

Moreover, a reactor according to the present disclosure includes:
a pair of molded cores the covers at least respective parts of core members with a core molding resin;
a molded coil that covers at least respective parts of coils with a coil molding resin;
an adhesive that joins the molded cores with the molded coil; and
a busbar which is connected to a lead wire of the one coil by welding, and which is fixed to the molded core,
in which:
   the core members each include a plurality of leg portions, and a yoke portion that connects the leg portions;
   the coils are attached to the respective leg portions; and
   the adhesive includes:
   a core joining portion which is disposed between the respective joining surfaces of the leg portions of the one core member, and which joins the core members;
   an X-direction restricting portion which is disposed between an inner circumferential surface of the yoke portion and the molded coil, and which joins the inner circumferential surface and the molded coil;
   a Y-direction restricting portion which is disposed between at least one of inner side surfaces of the leg portions that are surfaces of the leg portions of the one core member facing each other and outer side surfaces of the leg portions that are surfaces each at an opposite side to the inner side surface, and, the molded coil, and which joins the internal side surface or the outer side surface and the molded coil; and
   a Z-direction restricting portion which is disposed between at least one of an upper surface of the leg portion and a lower surface thereof, and, the molded coil, and which joins the upper surface or the lower surface and the molded coil.

According to the present disclosure, it is possible to obtain a method for manufacturing a reactor and a reactor which firmly join molded cores and a molded coil, and which prevent damage to a welded portion between a busbar and a lead wire.

### BRIEF DESCRIPTION OF THE DRAWINGS

FIG. 1 is a perspective view illustrating an entire structure of a reactor;

FIG. 2 is a perspective view illustrating an entire structure of a molded core;

FIG. 3 is a perspective view of a core member;

FIG. 4 is a perspective view of a molded coil;

FIG. 5 is a perspective view of a coil;

FIG. 6 is an enlarged view of a protrusion;

FIG. 7 is an schematic diagram illustrating locations where an adhesive is formed; and

FIG. 8 is a diagram illustrating a manner of applying the adhesive to a joining surface.

### DETAILED DESCRIPTION OF THE EMBODIMENTS

### Embodiments

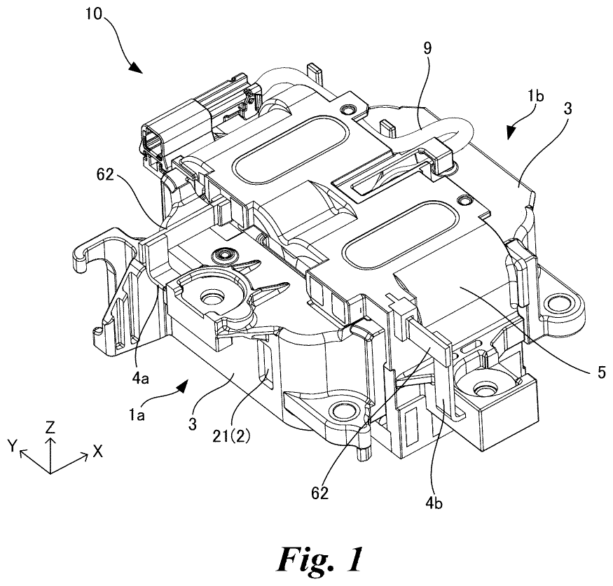

A reactor according to an embodiment will be described with reference to the figures. FIG. 1 is a perspective view illustrating an entire structure of a reactor 10. In each figure, for ease of understanding, thicknesses, dimensions, positional relationships, a ratio or a shape, etc., may be illustrated in an emphasized manner, and such an emphasis does not limit the scope and spirit of the present disclosure.

Note that the winding-axis direction of a coil 6 is the X-direction illustrated in FIG. 1, the arrangement direction of the leg portions of the core member is the Y-direction illustrated in FIG. 1 and is also referred to as the width direction and, the direction orthogonal to the winding-axis direction and the width direction is the Z-direction illustrated in FIG. 1, and is also referred to as the height direction.

The reactor 10 is an electromagnetic component which converts electrical energy into magnetic energy, and which charges or discharges such energy, and is applied in various applications, such as Office Automation equipment, solar power generation systems, and automobiles. The reactor 10 includes a pair of molded cores 1a and 1b, and a molded coil 5.

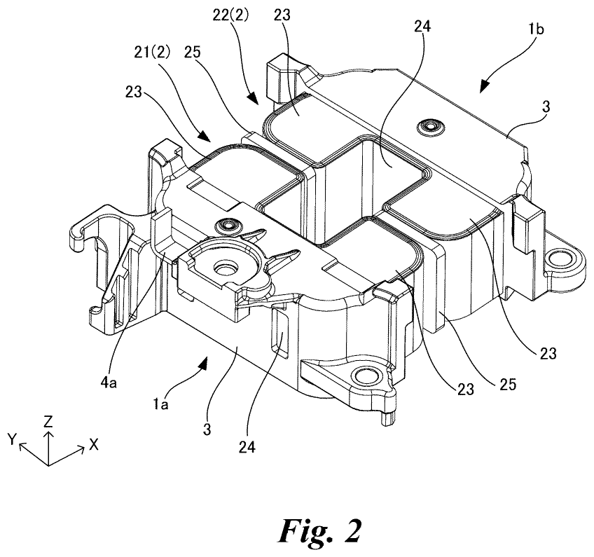

FIG. 2 is a perspective view illustrating an entire structure of the molded cores 1a and 1b. The molded cores 1a and 1b are produced by molding, with a core molding resin 3, respective core members 21 and 22 that constitute a core 2.

As for the core 2, a powder magnetic core, a ferrite core, laminated steel plates or a metal composite core, etc., may be used. A metal composite core is a magnetic body obtained by kneading magnetic powders and a resin together and curing the resin.

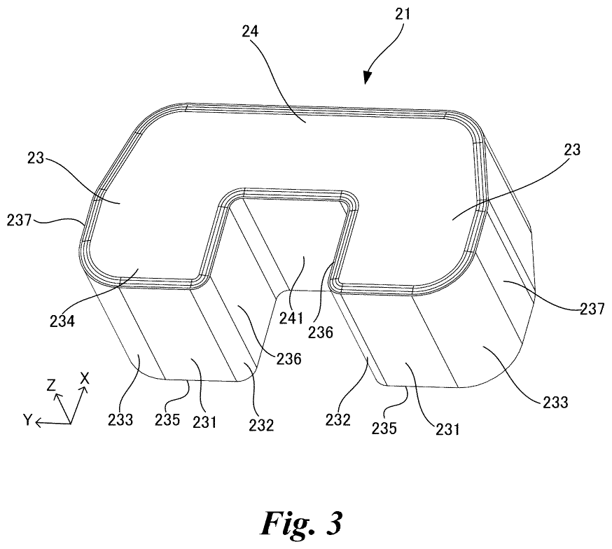

The core 2 includes the pair of core members 21 and 22. The core members 21 and 22 are identical in shape and size. FIG. 3 is a perspective view of the core member 21. The core member 21 has a U-shaped including a pair of leg portions 23 that extends in the winding-axis direction, and a yoke portion 24 that connects the pair of leg portions 23. A coil 6 is attached to each leg portion 23.

A tip surface of the leg portion 23 includes a joining surface 231, an inner curved surface 232, and an outer curved surface 233. The tip surface of the leg portion 23 refers to an end face orthogonal to the winding-axis direction, which is an end face opposite to a side where the yoke portion 24 is connected. The joining surface 231 is a flat surface. The joining surface 231 is disposed on the inner-curved-surface-232 side relative to the center position of the leg portion 23 in the width direction (the Y-direction). That is, the center position of the joining surface 231 in the width direction is located on the inner-curved-surface-232 side relative to the center position of the leg portion 23 in the width direction. By joining the respective joining surfaces 231 of the core members 21 and 22, the core 2 becomes an annular shape. The core 2 serves as a closed magnetic path through which magnetic fluxes generated by the coil 6 pass.

In this embodiment, spacers 25 are provided between respective joining surfaces 231 of the core members 21 and 22 (see FIG. 2). As for the spacer 25, a non-magnetic body, ceramics, a non-metal material, resin, carbon fiber or a combined member of two or more of these, or gap paper are applicable. By joining the core members 21 and 22 via the spacers 25 as described above, a magnetic gap with a predetermined width is provided, thereby preventing a decrease in the inductance of the reactor 10. Moreover, the core members 21 and 22 may be joined directly with an adhesive without the gap being provided therebetween.

The inner curved surface 232 is provided at the inner corner of the tip surface of the leg portion 23. The inner curved surface 232 is disposed between the joining surface 231 and an inner side surface 236 to be described later, and connects the joining surface 231 and the inner side surface 236. The inner curved surface 232 is curved. The outer curved surface 233 is provided at the outer corner of the tip surface of the leg portion 23. The outer curved surface 233 is disposed between the joining surface 231 and an outer side surface 237 to be described later, and connects the joining surface 231 and the outer side surface 237. In other words, the joining surface 231 is provided between the inner curved surface 232 and the outer curved surface 233. The bend radius of the inner curved surface 232 is smaller than that of the outer curved surface 233. That is, the outer curved surface 233 is more gently curved than the inner curved surface 232. Moreover, the surface area of the inner curved surface 232 is smaller than the surface area of the outer curved surface 233. Note that the inner refers to a direction toward the center of the reactor 10, and the outer refers to a direction away from the center of the reactor 10.

The leg portion 23 includes an upper surface 234 and a lower surface 235 that are orthogonal to the height direction. The upper surface 234 and the lower surface 235 are each a flat surface. The upper surface 234 and the lower surface 235 are each continuously connected to the joining surfaces 231. Moreover, each leg portion 23 includes an inner side surface 236 and an outer side surface 237 that are orthogonal to the width direction. The inner side surface 236 is a surface on which the pair of leg portions 23 face each other, and the side surface 237 is a surface on the opposite side to the inner side surface 236. The inner side surface 236 and the outer side surface 237 are each a flat surface. The inner side surface 236 is continuously connected to the inner curved surface 232. The outer side surface 237 is continuously connected to the outer curved surface 233.

The yoke portion 24 connects the pair of leg portions 23. The yoke portion 24 is covered with the core molding resin 3. However, an inner circumferential surface 241 of the yoke portion 24 is not covered with the core molding resin 3, and is exposed as it is. The inner circumferential surface 241 of the yoke portion 24 is a surface orthogonal to the winding axis direction, and is a surface (a surface formed between the leg portions 23) that faces with an annular surface 61 of coil 6 to be described later.

Returning to FIG. 2, the core molding resin 3 is formed by molding the core members 21 and 22, respectively. The core molding resin 3 is integrated with the respective core members 21 and 22. As illustrated in FIG. 2, such a resin covers the core members 21 and 22 partially. In this embodiment, the core molding resin 3 covers only the yoke portion 24 of each core member 21, 22. In other words, the leg portions 23 of each core member 21, 22 are not covered by the core molding resin 3, and are exposed as those are. Moreover, the core molding resin 3 does not cover the inner circumferential surface 241 of the yoke portion 24, and the inner circumferential surface 241 is exposed as it is.

The core molding resin 3 is formed of a resin. Example kinds of the resin for the core molding resin 3 include, for example, epoxy resin, unsaturated polyester-based resin, urethane resin, Bulk Molding Compound (BMC), Polyphenylene Sulfide (PPS), Polybutylene Terephthalate (PBT) or a composites thereof. Moreover, a thermally-conductive filler may also be mixed with the resin. In this embodiment, PPS is applied for the core molding resin 3.

Note that, the molded core 1a includes a busbar 4a. For example, the busbar 4a is a conductive member formed in a plate shape, such as copper or aluminum. The bus bar 4a is covered with the core molding resin 3, and is fixed to the molded core 1a. The busbar 4a is connected to a lead wire 62 of the one coil 6 by welding. Moreover, the busbar 4a is connected to a connection terminal of an external device. The reactor 10 is electrically connected to the external device via the bus bar 4a.

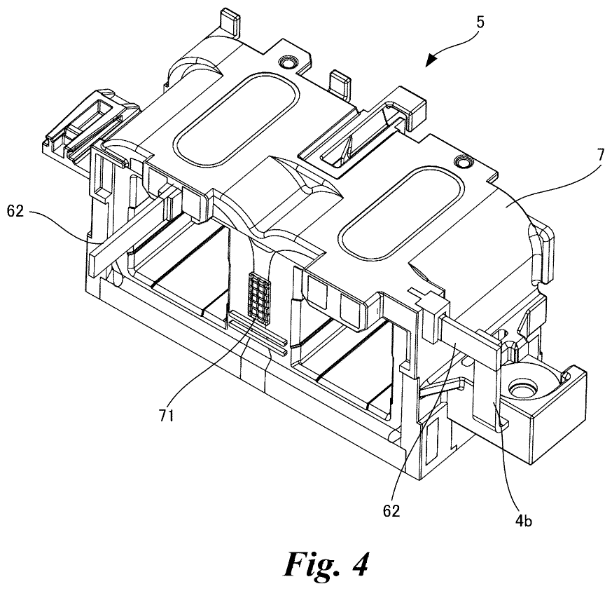

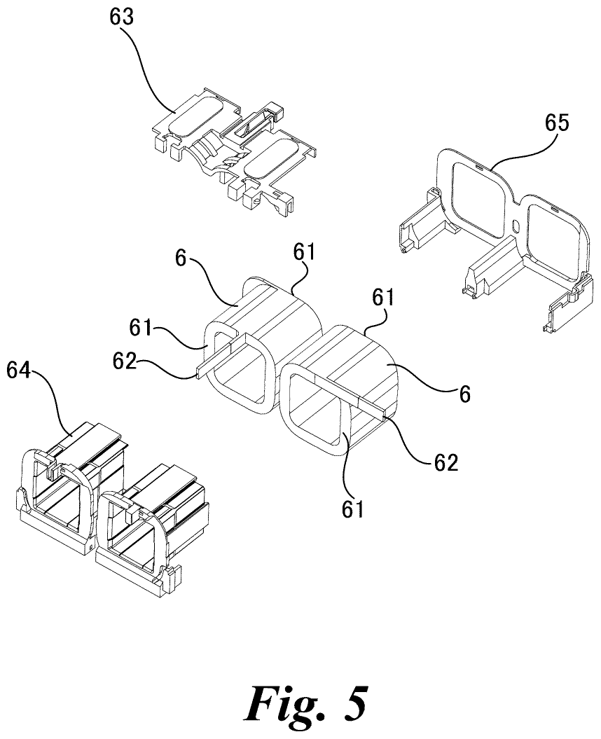

FIG. 4 is a perspective view of the molded coil 5. FIG. 5 is a perspective view of the coil 6. The molded coil 5 includes the coils 6 and a coil molding resin 7. The molded coil 5 is produced by molding the coils 6 with the coil molding resin 7.

The coil 6 is formed by a single conductive member in a flat rectangular shape which is covered with enamel, or the like, for insulation. The coil 6 is formed by winding the conductive member cylindrically while sifting the winding position in the winding axis direction. In this embodiment, the coil is an edgewise coil with a flat rectangular wire that is a copper wire. Note that the kind of the wire of the coil 6 and the winding scheme thereof are not limited to these examples, and other kinds and schemes are also applicable.

The two coils 6 are provided. The coils 6 are arranged side by side in such a way that the respective outer circumferential surfaces of the coil 6 extending along the winding axis face with each other. The coil 6 includes the annular surface 61 orthogonal to the winding axis. From each coil 6, the lead wire 62 that becomes an end of the conductive members is drawn out from the one annular surface 61. The lead wires 62 are connected to the busbars 4a and 4b, respectively, by welding. The coil 6 is energized via the busbars 4a and 4b and, and magnetic fluxes are generated.

Note that an upper cover 63, an inner circumference cover 64 and a lower cover 65 are provided around the coil 6. The upper cover 63, the inner circumference cover 64 and the lower cover 65 are each formed of a resin. The upper cover 63 covers the upper surfaces of the coils 6. The inner circumference cover 64 covers the inner circumferential surfaces of the respective coils 6 and the annular surfaces 61 thereof at one side. In this embodiment, in the inner circumference cover 64, portions that cover the respective inner circumferential surfaces of the coils 6 are not covered with the coil molding resin 7. That is, the inner circumferential surface of the molded coil 5 is formed by the inner circumference cover 64. The lower cover 65 covers the lower surfaces of the respective coils 6, and the annular surfaces 61 thereof at the other side. Since the surroundings of the coils 6 are covered with the upper cover 63, the inner circumference cover 64 and the lower cover 65, the coil 6 is prevented from directly contacting with a die, a depressing member, a jig or an injected resin, etc., during molding.

The coil molding resin 7 covers the surroundings of the coils 6 directly or by various covers 63, 64 and 65. The coil molding resin 7 is formed of a resin. Example kinds of the resin for the coil molding resin 7 include epoxy resin, unsaturated polyester-based resin, urethane resin, Bulk Molding Compound (BMC), Polyphenylene Sulfide (PPS), Polybutylene Terephthalate (PBT) or a composite thereof. Moreover, a thermally-conductive filler may be mixed with the resin.

As illustrated in FIG. 4, the coil molding resin 7 includes protrusions 71. The two protrusions 71 are provided. The protrusions 71 are provided on the respective end faces of the coil molding resin 7 orthogonal to the winding axis. More specifically, each protrusion 71 is provided between the annular surfaces 61 of the pair of coils 6. The protrusion 71 is provided at the center portion of the reactor 10 in the height direction. The protrusion 71 extends from the end face of the coil molding resin 7 orthogonal to the winding axis toward the inner circumferential surface 241 of the yoke portion 24. That is, the protrusion 71 faces the inner circumferential surface 241 of the yoke portion 24.

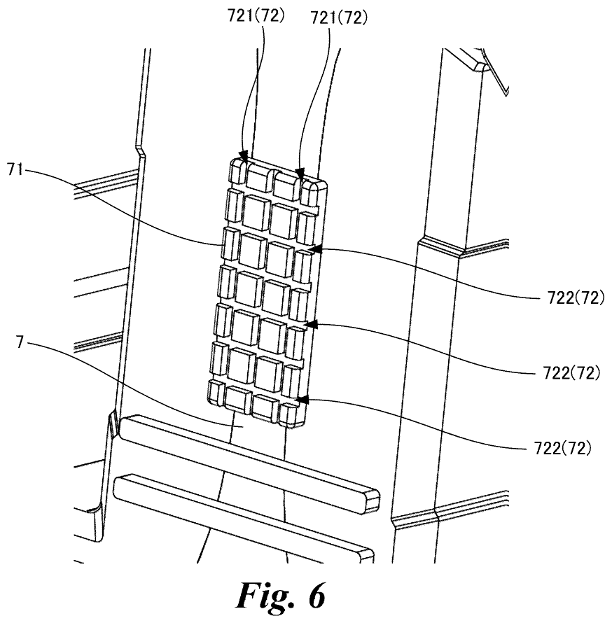

FIG. 6 is an enlarged view of the protrusion 71. The protrusion 71 is formed in, without being limited thereto, a rectangular tabular shape. However, a plurality of grooves 72 are formed in the protrusion 71. The grooves 72 notch the protrusion 71. The depth of each groove 72 is shorter than the protruding length of the protrusion 71. In other words, the grooves 72 do not notch as far as the bottom surface of the protrusion 71, i.e., the position of the end face of the coil molding resin 7 where the protrusion 71 is not formed.

The grooves 72 include a plurality of vertical grooves 721 and a plurality of horizontal grooves 722. The vertical groove 721 extends in the height direction. The plurality of vertical grooves 721 are arranged at equal intervals. In this embodiment, the three vertical grooves 721 are formed. The horizontal groove 722 extends in the width direction. That is, the horizontal groove 722 extends so as to intersect with the vertical groove 721 in a manner orthogonal thereto. The plurality of horizontal grooves 722 are arranged at equal intervals. In this embodiment, the six horizontal grooves 722 are formed. Hence, the protrusion 71 is formed in a lattice shape by the vertical grooves 721 and by the horizontal groove 722.

Note that the molded coil 5 includes the busbar 4b. The busbar 4b is covered with the coil molding resin 7, and is fixed to the molded coil 5. The busbar 4b is connected to the lead wire 62 of the other coil 6 by welding. Moreover, the busbar 4b is connected to a connection terminal of the external device.

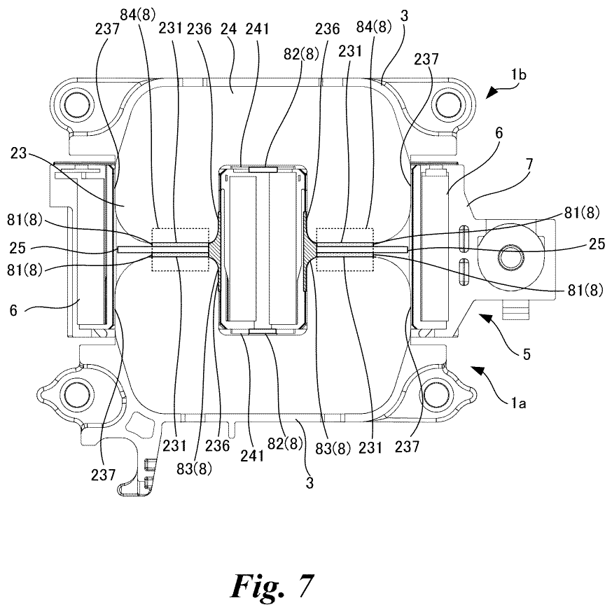

The above-described molded cores 1a and 1b and molded coil 5 are fixed by an adhesive 8. In this embodiment, although an epoxy resin is applied as the adhesive 8, the other adhesives may be applied. FIG. 7 is a schematic diagram illustrating locations where the adhesive 8 is formed. As illustrated in FIG. 7, the adhesive 8 includes core joining portions 81, X-direction restricting portions 82, Y-direction restricting portions 83 and Z-direction restricting portions 84. Note that the core joining portions 81, the X-direction restricting portions 82, the Y-direction restricting portions 83 and the Z-direction restricting portions 84 are formed by the cured adhesive 8 in a curing process to be described later.

The core joining portion 81 is formed between the joining surfaces 231 of the respective leg portions 23 of the core member 21 and those of the core member 22. The core joining portion 81 abuts each joining surface 231, and joins the core members 21 and 22. In this embodiment, since the spacers 25 are interposed between the respective joining surfaces 231, the core joining portions 81 are formed between the joining surfaces 231 of the core member 21 and the corresponding spacers 25, and between the joining surfaces 231 of the core member 22 and the corresponding spacers 25. Accordingly, the core joining portion 81 abuts each joining surface 231 and the spacers 25, and the core members 21 and 22 are joined via the spacers 25.

The X-direction restricting portion 82 is formed between the inner circumferential surface 241 of the yoke portion 24 of each of the core members 21 and 22, and, each of the protrusions 71 of the coil molding resin 7. Each X-direction restricting portion 82 abuts each inner circumferential surface 241 and each protrusion 71. The X-direction restricting portion 82 is also formed in the interiors of the vertical grooves 721 and the horizontal grooves 722 of each protrusion 71. The X-direction restricting portion 82 joins and fixes the inner circumferential surface 241 of each of the molded cores 1a and 1b and each of the protrusions 71 of the molded coil 5. Note that the X-direction restricting portion 82 may be formed so as to extend beyond the size of the protrusion 71.

The Y-direction restricting portion 83 is formed between at least one of the inner side surfaces 236 of each of the core members 21 and 22 and the external side surfaces 237 thereof, and, the inner circumferential surface of the molded coil 5 (the inner circumference covers 64 that cover the respective inner circumferential surfaces of the coils 6). In this embodiment, the Y-direction restricting portion 83 is formed only on each inner side surface 236. The Y-direction restricting portion 83 abuts each inner side surface 236 of each of the core members 21 and 22, and the inner circumference cover 64. The Y-direction restricting portion 83 extends over the respective inner side surfaces of both of the core members 21 and 22. That is, each Y-direction restricting portion 83 also abuts each inner curved surface 232 of each of the core members 21 and 22, and each of the spacers 25, and is also formed in a space defined by the inner curved surface 232 of each of the core members 21 and 22, each of the spacers 25 and the inner circumference cover 64. The Y-direction restricting portion 83 joins and fixes the respective inner side surfaces 236 of the molded cores 1a and 1b with the respective inner circumference covers 64 of the molded coil 5. Note that each Y-direction restricting portion 83 is continuously connected to each core joining portion 81.

The Z-direction restricting portion 84 is formed between at least either one of the upper surface 234 of each of the core members 21 and 22 and the lower surface 235 thereof, and, each inner circumference cover 64 that covers the inner circumferential surface of the coil 6. In this embodiment, the Z-direction restricting portion 84 is formed on both of the upper surface 234 of each of the core members 21 and 22 and the lower surface 235 thereof. The Z-direction restricting portion 84 abuts the upper surface 234 of each of the core members 21 and 22, the lower surface 235 thereof, and each inner circumference cover 64. The Z-direction restricting portion 84 extends over the upper surface 234 of each of the core members 21 and 22, and the lower surface 235 thereof. That is, the Z-direction restricting portion 84 also abuts the upper surface of the core joining portion 81 and the lower surface thereof, and the spacer 25. The Z-direction restricting portion 84 joins and fixes the upper surface 234 of each of the molded cores 1a and 1b and the lower surface 235 thereof with the inner circumference cover 64 of the molded coil 5.

In this embodiment, the reactor 10 further includes a sensor 9. The sensor 9 measures a physical quantity of the reactor 10. As for the sensor 9, for example, a thermistor that changes an electric resistance relative to a temperature change is applicable. In fact, the sensor 9 is not limited to a thermistor, and a magnetic sensor, a current sensor, a thermal fuse, etc., may be applied instead.

### Production Method

Next, a manufacturing method of the reactor 10 in this embodiment will be described. The manufacturing method of the reactor 10 includes a molded core forming process, a molded coil forming process, a bonding process, and a welding process.

The molded core forming process is a process of forming the respective molded cores 1a and 1b by molding. The core member 21 is accommodated in a die, and the core molding resin 3 is injected into the die. Next, the core molding resin 3 is cured to form the molded core 1a. Similarly, the core member 22 is accommodated in a die, the core molding resin 3 is injected into the die, and the core molding resin 3 is cured to form the molded core 1b. Note that when the molded core 1a is to be formed, the busbar 4a is also accommodated in the die, and is molded together with the core member 21. Hence, the busbar 4a is fixed to the molded core 1a.

The molded coil forming process is a process of forming the molded coil 5 by molding. The coils 6 and the busbar 4b are accommodated in a die, and the coil molding resin 7 is injected into the die. Next, the coil molding resin 7 is cured so as to form the molded coil 5.

Note that either the molded core forming process or the molded coil forming process may be performed in first. Moreover, the molded core forming process and the molded coil forming process may be processed simultaneously.

The bonding process is a process of joining and fixing the molded cores 1a and 1b with the molded coil 5 by the adhesive 8. The bonding process includes an applying process, a depressing process, and a curing process.

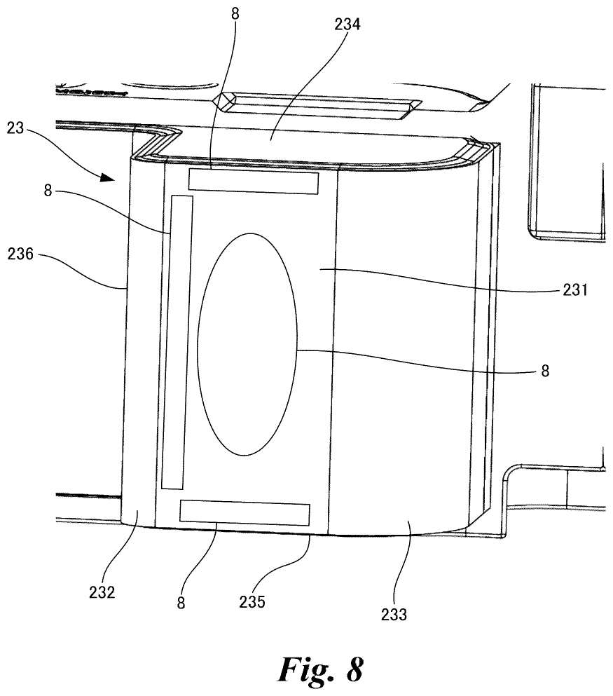

The applying process is process of applying the adhesive 8 to the molded cores 1a and 1b, and the molded coil. First, the adhesive 8 is applied to the inner circumferential surfaces 241 of the yoke portions 24 of the molded core 1a, and the joining surfaces 231 of the respective leg portions 23 of the molded core 1a. FIG. 8 is a diagram illustrating how to apply the adhesive 8 to the joining surface 231. As illustrated in FIG. 8, the adhesive 8 is applied to the center portion of the joining surface 231, to a vicinity of the edge of each leg portion 23 on the upper-surface-234 side, to a vicinity of the edge on the lower-surface-235 side, and to a vicinity of the edge on the inner-side-surface-236 side. The adhesive 8 is applied to the joining surface 231 by such an amount that the applied adhesive 8 to the joining surface 231 is spread onto, by the depressing process, the upper surface 234, lower surface 235 and inner side surface 236 of each leg portion 23, and fills gap between the upper surface 234, lower surface 235 and inner side surface 236 of the leg portion 23 and the inner circumferential surface of the molded coil 5.

Next, the molded coil 5 is inserted into the leg portions 23 of the molded core 1a. At this time, the adhesive 8 applied to the inner circumferential surface 241 of the molded core 1a sticks to the one protrusion 71 of molded coil 5. After the molded coil 5 is inserted into the predetermined position, the spacers 25 are inserted into the inner circumferential surface of the molded coil 5 so as to be stuck with the adhesive 8 applied to the joining surfaces 231.

Finally, the adhesive 8 is applied to the inner circumferential surface 241 of the yoke portion 24 of the molded core 1b and the respective joining surfaces 231 of the leg portions 23 of the molded core 1b. As for the application to the joining surface 231, similarly to the molded core 1a, as illustrated in FIG. 8, the adhesive 8 is applied to the center portion of the joining surface 231, to a vicinity of the edge of each leg portion 23 on the upper-surface-234 side, to a vicinity of the edge on the lower-surface-235 side, and to a vicinity of the edge on the inner-side-surface-236 side. Next, the molded core 1b is inserted into the molded coil 5. The molded core 1b is inserted until the adhesive 8 applied to the inner circumferential surface 241 of the molded core 1b sticks to the other protrusion 71 of the molded coil 5.

When the insertion of the molded core 1b in the molded coil 5 completes, the process progresses to the depressing process. The depressing process is a process of depressing the molded cores 1a and 1b so as to spread the adhesive 8 by such depression. The molded cores 1a and 1b are depressed in such a way that the back surfaces (the surfaces opposite to the respective inner circumferential surfaces 241) of the respective yoke portions 24 of the molded cores 1a and 1b are depressed along the winding axis direction. The adhesive 8 applied to the joining surfaces are depressed and is spread so as to stick to each entire joining surface 231 by such a depression.

By further depressing, the adhesive 8 applied to each joining surface 231 is spread from the joining surface 231 onto the upper surface 234, lower surface 235 and inner side surface 236 of each leg portion 23. The extruded adhesive 8 spreads into a space between the upper surface 234 or the lower surface 235 and the inner circumferential surface of the molded coil 5, and sticks to the upper surface 234, lower surface 235 and inner circumferential surface of the molded coil 5. Moreover, the extruded adhesive 8 fills a space between the inner curved surface 232 and the inner circumferential surface of the molded coil 5, spreads into the a space between the inner side surface 236 and the molded coil 5, and sticks to the inner side surface 236 and the inner circumferential surface of the molded coil 5. Moreover, the adhesive 8 applied to the inner circumferential surface 241 of each yoke portion 24 is depressed and is spread on the inner circumferential surface 241, and enters the vertical grooves 721 of each protrusion 71 and the horizontal grooves 722 thereof.

After the depressing process completes, the process progresses to the curing process. The curing process is a process of curing the adhesive 8 by drying. For example, the adhesive 8 is exposed to heat for curing. As for the temperature and the time for such exposure to heat, the optimized temperature and time may be selected in accordance with the material of the adhesive. Hence, the adhesive 8 is cured, and thus the core joining portions 81, the X-direction restricting portions 82, the Y-direction restricting portions 83, and the Z-direction restricting portions 84 are formed. The core members 21 and 22 are joined by the core joining portions 81, and thus the annular core 2 is formed. Moreover, the molded cores 1a and 1b are joined with and fixed to the molded coil 5 by the X-direction restricting portions 82, the Y-direction restricting portions 83, and the Z-direction restricting portions 84.

The welding process is a process of joining the lead wires 62 of the coils 6 and the busbars 4a and 4b, respectively, by welding. After the welding process completes, the lead wires 62 and the busbars 4a and 4b are fixed in the connected states.

### Actions and Effects

As described above, the reactor 10 according to this embodiment includes: the pair of the molded cores 1a and 1b that covers at least respective parts of the core members 21 and 22 with the core molding resin 3; the molded coil 5 that covers at least respective parts of the coils 6 with the coil molding resin 7; the adhesive 8 that joins the molded cores 1a and 1b with the molded coil 5; and the busbar 4a which is connected to the lead wire 62 of the one coil 6 by welding, and which is fixed to the molded core 1a. The core members 21 and 22 each include the plurality of leg portions 23, and the yoke portion 24 that connects the leg portions 23, and the coils 6 are attached to the respective leg portions 23. The adhesive 8 includes: the core joining portion 81 disposed between the joining surfaces 231 of the respective leg portions 23, and joins the core members 21 and 22; the X-direction restricting portion 82 disposed between the inner circumferential surface 241 of the yoke portion 24 and the molded coil 5, and joins the inner circumferential surface 241 and the molded coil 5; the Y-direction restricting portion 83 disposed between the inner side surface 236 of the leg portion 23 and the molded coil 5, and joins the inner side surface 236 and the molded coil 5; and the Z-direction restricting portion 84 disposed between the upper surface 234 of the leg portion 23 and the lower surface 235 thereof, and, the molded coil 5, and joins the upper surface 234 or the lower surface 235 and the molded coil 5.

As described above, as for the molded cores 1a and 1b and the molded coil 5, any movement in the X-direction (the winding axis direction) is restricted by the X-direction restricting portions 82, any movement in the Y-direction (the width direction) is restricted by the Y-direction restricting portions 83, and any movement in the Z-direction (the height direction) is restricted by the Z-direction restricting portions 84. That is, the molded cores 1a and 1b and the molded coil 5 are joined in all three axial directions by the X-direction restricting portions 82, the Y-direction restricting portions 83 and the Z-direction restricting portions 84, and thus any movements in such directions are restricted. Therefore, even if the reactor 10 is mounted on an environment in which vibration occurs, any movement of the molded cores 1a and 1b and molded coil 5 is suppressed. This prevents the welded portion between the lead wire 62 and the busbar 4a fixed to the molded core 1a from being damaged due to excessive stress applied thereto. Although the molded core 1b does not include the busbar, the molded core 1b is joined with the molded core 1a by the core joining portions 81. Hence, if the molded core 1b moves due to vibration, this may give an adverse effect to the molded core 1a. Accordingly, it is preferable that the molded core 1b should be also joined to the molded coil 5 in the three axial directions, and any movement in such directions should be restricted.

When the coils 6 are not molded by the coil molding resin 7, even if vibration is applied to the reactor, since the coils 6 are wound in a spiral shape, the coils 6 can respectively serve as springs that absorb vibration. Hence, stress that is applied to the welded portion can be eased to some extent. On the other hand, as in this embodiment, when the coils 6 are molded with the coil molding resin 7, the functions of the respective coils 6 as springs are not accomplished. Hence, the coils 6 do not absorb vibration, and thus stress is likely to be applied to the welded portion. Moreover, since the coils 6 molded by the coil molding resin 8 become a singular bulk with a weight to some extent, stress to be applied to the weld portion further increases. According to this embodiment, however, since the molded cores 1a and 1b are joined to the molded coil 5 in all three axial directions by the adhesive 8, and any movement of those components in such directions is restricted, it is possible to suppress excessive stress from being applied to the welded portion due to vibration.

Moreover, each Y-direction restricting portion 83 is disposed between each inner side surface 236 and the molded coil 5. That is, since each Y-direction restricting portion 83 is formed at the position closer to the weighted center of the reactor 10, the rigidity is enhanced. This prevents the welded portion from being damaged due to excessive stress applied by vibration. Furthermore, although the center portion of the coil 6 becomes high in temperature, each Y-direction restricting portion 83 also serves as a heat dissipation path. Hence, the heat dissipation performance by the reactor 10 increases.

The manufacturing method of the reactor 10 according to this embodiment includes: the molded core forming process of forming the pair of molded cores 1a and 1b by molding the core members 21 and 22 with the core molding resin 3; the molded coil forming process of forming the molded coil 5 by molding the coils 6 with the coil molding resin 7; the bonding process of joining the molded cores 1a and 1b with the molded coil 5 with the adhesive 8; and the welding process of connecting, by welding, the lead wire 62 of the coil 6 to the busbar 4a fixed to the molded core 1a. The core members 21 and 22 each include the plurality of leg portions 23, and the yoke portion 24 that connects the leg portions 23, and the coils 6 are attached to the respective leg portions 23. The bonding process includes: the applying process of applying the adhesive 8 to the joining surfaces 231 of the respective leg portions 23 of each of the core members 21 and 22, and the inner circumferential surfaces 241 of the respective yoke portions 24 of the core members 21 and 22; the depressing process of spreading the applied adhesive 8 by depression; and the curing process of curing the adhesive 8. In the depressing process, the adhesive 8 applied to the joining surface 231 is spread by depression onto both of the upper surface 234 of each leg portion 23 and the lower surface 235 thereof, and the inner side surface 236 of such a leg portion, and to stick to the molded coil 5.

By depressing the adhesive 8 applied to the joining surface 231 so as to be spread onto the upper surface 234 of the leg portion 23 and the lower surface 235 thereof and also the inner side surface 236 as described above, in comparison with a case in which the adhesive is applied to respective portions, the productivity increases. Note that in this embodiment, although the adhesive 8 is spread onto both of the upper surface 234 of the leg portion 23 and the lower surface 235 thereof, it is sufficient if the adhesive should be spread onto at least one of the upper surface 234 and the lower surface 235. Such a structure can still achieve effects of fixing the molded cores 1a and 1b, and, the molded coil 5, and suppressing excessive stress to be applied due to vibration to the welded portion between the lead wire 62 and the busbar 4a fixed to the molded core 1a.

The coil molding resin 7 includes the protrusion 71 which faces with the inner circumferential surface 241 of each yoke portion 24, and which protrudes toward the inner circumferential surface 241. The protrusion 71 includes the grooves 72, and each X-direction restricting portion 82 abuts each protrusion 71, and is formed in the grooves 72.

Hence, the X-direction restricting portion 82 has the increased surface area that abuts with the coil molding resin 7. Therefore, the joining strength between the molded cores 1a and 1b, and, the molded coil 5 is increased. Thus, stress to be applied by vibration to the welded portion between the lead wire 62 and the busbar 4a can be effectively suppressed.

The coil molding resin 7 is formed of Polyphenylene Sulfide (PPS), and the adhesive 8 is formed of an epoxy resin. PPS and epoxy resin are incompatible with each other, and thus the bonding strength therebetween tends to decrease. According to this embodiment, however, the grooves 72 is provided in each protrusion 71, and the adhesive 8 is allowed to enter inside the grooves 72, and each X-direction restricting portion 82 is formed even in the interiors of the grooves 72. Hence, even if the materials that are incompatible with each other are adopted, the molded cores 1a and 1b, and, the molded coil 5 are firmly joined by the respective inner circumferential surfaces 241 of the yoke portions 24 and by the respective protrusions 71 of the coil molding resin 7, and thus any movement in the X-direction is restricted.

In particular, according to this embodiment, the grooves 72 are formed by the plurality of vertical grooves 721 and the plurality of horizontal grooves 722, and the protrusion 71 is formed in a lattice shape. Hence, the X-direction restricting portions 82 can further increase the joining strength between the molded cores 1a and 1b, and, the molded coil 5, which is achieved by the X-direction restricting portions 82.

### Other Embodiments

Although the embodiment of the present disclosure has been described above in the specification, the embodiment is merely presented as an example, and is not intended to limit the scope and spirit of the present disclosure. The above-described embodiment can be carried out in other various forms, and various omissions, replacements, and modifications can be made thereto without departing from the scope and spirit of the present disclosure. The embodiment and the modified examples thereof are within the scope and spirt of the present disclosure, and also fall in the scope and spirit of the invention as recited in the appended claims and the equivalents thereof.

In the above-described embodiment, although each Y-direction restricting portion 83 is formed between each inner side surface 236 and the molded coil 5, it may be formed between each outer side surface 237 and the molded coil 5. Such a structure can also allow the respective outer side surfaces 237 of the molded cores 1a and 1b, and, the molded coil 5 to be joined by the Y-direction restricting portions 83, and thus any movement of the molded cores 1a and 1b, and the molded coil 5 in the Y-direction (the widthwise direction) can be restricted. Moreover, by providing each Y-direction restricting portion 83 at the outer-side-surface-237 side, in the depressing process, when the coil 6 is viewed from the annular surface 61 of each coil 6 in the winding axis direction, it can be checked whether the adhesive 8 is spread into or not into the gap between the outer side surface 237 and the inner circumferential surface of the molded coil 5 (the inner circumference cover 64).

Moreover, the Y-direction restricting portions 83 may be formed on both of each inner side surface 236 and each outer side surface 237. This enables both of the inner side surface 236 and the outer side surface 237 to be joined with the molded coil 5, increasing the joining strength.

In the above-described embodiment, when the X-direction restricting portion 82 is formed, the adhesive 8 is applied to the inner circumferential surface 241 of the yoke portion 24, but it may be applied to the molded coil 5 that faces with the inner circumferential surface 241 without such an adhesive being applied to the inner circumferential surface 241. That is, the adhesive may be applied to each protrusion 71 of the molded coil 5.

Moreover, the protrusions 71 may be provided on the molded cores 1a and 1b. For example, the inner circumferential surface 241 of the yoke portion 24 may be covered with the core molding resin 3. In addition, the protrusions 71 that protrude toward the respective annular surfaces 61 of the coils 6 may be provided on the core molding resin 3.

In the above-described embodiment, in addition to the center portion of each joining surface 231, the adhesive 8 is applied to a vicinity of the edge of each joining surface 231 on the upper-surface-234 side, a vicinity of the edge on the lower-surface-235 side, and a vicinity of the edge on the internal-side-surface-236 side, but it may be applied to only the center portion as far as the adhesive 8 can be spread onto the upper surface 234, lower surface 235 and internal side surface 236 of each leg portion 23.

In the above-described embodiment, although the busbar 4a is covered with the core molding resin 3 by molding, the scheme of fixing the busbar 4a to the molded core 1a is not limited to this scheme. For example, a terminal block that includes the busbar 4a may be formed as a separate component from the molded core 1a, and such a terminal block may be fixed to the molded core 1a by fasteners like bolts. Such a structure can also suppress any movement of the molded cores 1a and 1b, and that of the molded coil 5, preventing the welded portion between the lead wire 62 and the busbar 4a from being damaged due to excessive stress applied thereto.

What is claimed is:

1. A method for manufacturing a reactor comprising:
a molded core forming process of forming a pair of molded cores by molding at least respective parts of core members with a core molding resin;
a molded coil forming process of forming a molded coil by molding at least respective parts of coils with a coil molding resin;
a bonding process of joining the molded cores with the molded coil with an adhesive; and
a welding process of connecting, by welding, a lead wire of the one coil to a busbar fixed to the molded core,
wherein:
the core members each comprise a plurality of leg portions, and a yoke portion that connects the leg portions;
the coils are attached to the respective leg portions;
the bonding process comprises:
an applying process of applying the adhesive to joining surfaces of the respective leg portions of each of the core members, and an inner circumferential surface of the yoke portion of each of the core members or the molded coil that faces the inner circumferential surface of the yoke portion;
a depressing process of spreading the applied adhesive by depression; and
a curing process of curing the adhesive,
in the depressing process, the adhesive applied to the joining surface is spread by depression onto at least one of an upper surface of the leg portion and a lower surface thereof, and at least one of inner side surfaces of the respective leg portions which are the surfaces of the respective leg portions of the one core member facing each other, and outer side surfaces of the respective leg portions which are surfaces each at an opposite side to the inner side surface, and to stick to the molded coil.

2. The method for manufacturing the reactor according to claim 1, wherein in the depressing process, the adhesive applied to the joining surface is spread by depression onto the inner side surface of the leg portion.

3. The method for manufacturing the reactor according to claim 1, wherein in the depressing process, the adhesive applied to the joining surface is spread by depression onto the outer side surface of the leg portion.

4. The method for manufacturing the reactor according to claim 1, wherein:
the coil molding resin comprises a protrusion which faces the inner circumferential surface of the yoke portion, and which protrudes toward the inner circumferential surface;
the protrusion comprises grooves; and
in the depressing process, the depression is made in such a way that the adhesive applied to the inner circumferential surface of the yoke portion or the molded coil facing with the inner circumferential surface of the yoke portion is caused to enter inside the grooves.

5. The method for manufacturing the reactor according to claim 4, wherein:
the coil molding resin is formed of Polyphenylene Sulfide (PPS); and
the adhesive is formed of an epoxy resin.

6. A reactor comprising:
a pair of molded cores the covers at least respective parts of core members with a core molding resin;
a molded coil that covers at least respective parts of coils with a coil molding resin;
an adhesive that joins the molded cores with the molded coil; and
a busbar which is connected to a lead wire of the one coil by welding, and which is fixed to the molded core,
wherein:
the core members each comprise a plurality of leg portions, and a yoke portion that connects the leg portions;
the coils are attached to the respective leg portions; and
the adhesive comprises:
a core joining portion which is disposed between the respective joining surfaces of the leg portions of the one core member, and which joins the core members;
an X-direction restricting portion which is disposed between an inner circumferential surface of the yoke portion and the molded coil, and which joins the inner circumferential surface and the molded coil;
a Y-direction restricting portion which is disposed between at least one of inner side surfaces of the leg portions that are surfaces of the leg portions of the one core member facing each other and outer side surfaces of the leg portions that are surfaces each at an opposite side to the inner side surface, and, the molded coil, and which joins the inner side surface or the outer side surface and the molded coil; and
a Z-direction restricting portion which is disposed between at least one of an upper surface of the leg portion and a lower surface thereof, and, the molded coil, and which joins the upper surface or the lower surface and the molded coil.

7. The reactor according to claim 6, wherein the Y-direction restricting portion is disposed between the inner side surface of the leg portion and the molded coil.

8. The reactor according to claim 6, wherein the Y-direction restricting portion is disposed between the outer side surface of the leg portion and the molded coil.

9. The reactor according to claim 6, wherein:
the coil molding resin comprises a protrusion which faces the inner circumferential surface of the yoke portion, and which protrudes toward the inner circumferential surface;
the protrusion comprises grooves; and
the X-direction restricting portion abuts the protrusion and is formed inside the grooves.

10. The reactor according to claim 9, wherein:
the coil molding resin is formed of Polyphenylene Sulfide (PPS); and
the adhesive is formed of an epoxy resin.
